(19) United States
(12) Patent Application Publication
(10) Pub. No.: US 2017/0351650 A1
(43) Pub. Date: Dec. 7, 2017

(54) DIGITAL CONVERSATION ANNOTATION

(71) Applicant: Cisco Technology, Inc., San Jose, CA (US)

(72) Inventors: Mingfeng YANG, Hefei (CN); Yasi XI, Hefei (CN); Shuqun NING, Hefei (CN); Kent CHEN, Hefei (CN)

(21) Appl. No.: 15/169,769

(22) Filed: Jun. 1, 2016

(51) Int. Cl. G06F 17/24; H04L 12/58; H04W 4/12

(52) U.S. Cl. CPC G06F 17/241; H04L 51/16; H04W 4/12

(57) ABSTRACT

A method for annotating digital conversations is implemented on a first computing device and includes: presenting participant posts from the digital conversation on a display screen of the first computing device, detecting input of at least an indication of an annotation associated with at least one of the participant posts, and presenting the annotation as superimposed on the at least one of the associated participant posts.

### FIELD OF THE INVENTION

The present invention generally relates to annotating an ongoing digital conversation in a collaborative environment.

### BACKGROUND OF THE INVENTION

Instant messaging (IM) and collaboration applications provide real-time text communication, often called “posts” or “chats”, between two or more participants, thereby supporting a “digital conversation” between the participants over a communications network, such as, for example, the Internet. Such applications often support maintaining the continuity of an ongoing digital conversation between its participants by saving the communications as they are sent as a conversation's “history”. Some or all of the digital conversation's history may be presented or made accessible to the participants when accessing a given conversation, typically, in reverse chronological order as per the time each post was contributed to the digital conversation.

### BRIEF DESCRIPTION OF THE DRAWINGS

The present invention will be understood and appreciated more fully from the following detailed description, taken in conjunction with the drawings in which:

FIGS. 1-14B are simplified pictorial illustrations of displays of an exemplary collaboration application, constructed and operative in accordance with embodiments described herein;

FIG. 15 is a block diagram of a computing device operative to run the exemplary collaboration application of FIGS. 1-14B; and

FIG. 16 is a flowchart of an exemplary conversation sub-window process to be executed on the computing device of FIG. 15 within the context of the exemplary collaboration application of FIGS. 1-14B.

### DESCRIPTION OF EXAMPLE EMBODIMENTS

### Overview

A method for annotating digital conversations is implemented on a first computing device and includes: presenting participant posts from the digital conversation on a display screen of the first computing device, detecting input of at least an indication of an annotation associated with at least one of the participant posts, and presenting the annotation as superimposed on the at least one of the associated participant posts.

### Detailed Description of Example Embodiments

It will be appreciated that as a digital conversation progresses, a participant may wish to comment on, or refer to, a specific post made earlier in the digital conversation. If such commenting or referencing is performed immediately following the specific post, the comment/reference may be entered as part of the natural flow of the digital conversation. For example, Participant A may post a statement about a given subject and Participant B may respond with a question about the statement in the next post in the digital conversation. In such a case, the context of Participant B's question may be clear to the other participants. However, in an ongoing digital conversation, there may be several intervening posts between Participant A's original statement and Participant B's question, thus rendering the context unclear. As collaboration applications, such as, for example, Cisco Spark, may support the participation of hundreds (or even more) participants in a given digital conversation over time, it may be difficult for the participants to unambiguously reference and/or comment on previous posts.

In accordance with embodiments described herein, digital conversation applications may be implemented with functionality to facilitate annotating previously made posts, thereby providing clearer context for comments and references, as well as also providing an enriched set of options for participant expression.

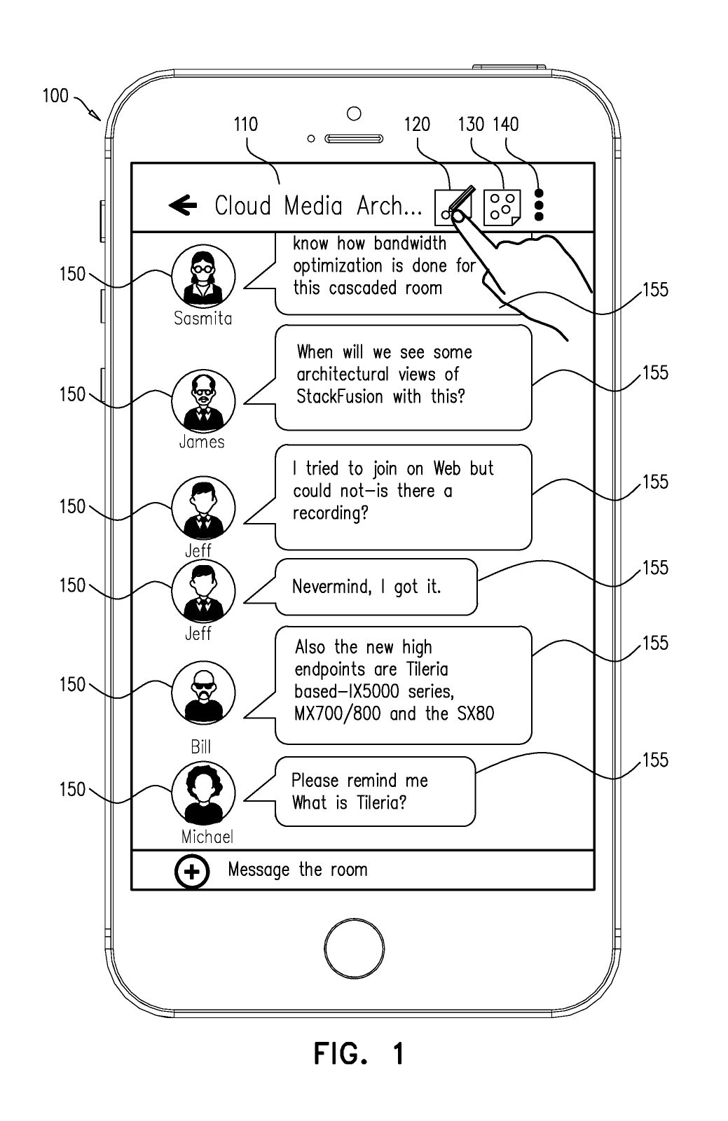

Reference is now made to FIG. 1 which is a simplified pictorial illustration of an exemplary digital conversation application display 100, constructed and operative in accordance with embodiments described herein. As depicted in the exemplary embodiment of FIG. 1, display 100 is presented on a smartphone device with touchscreen functionality. It will, however, be appreciated by one of ordinary skill in the art that the embodiments described herein may support implementation on other devices (e.g., computer tablets, personal computers, etc.) and/or other user interface functionalities (e.g., mouse clicks/hovers, keyboards, etc.) as well.

Display 100 comprises digital conversation label 110, annotation button 120, annotation view button 130, and menu button 140. Display 100 also comprises several participant posts 155, where each participant post 155 is associated with a participant as indicated by an associated participant avatar 150. Accordingly, as depicted in FIG. 1, display 100 may represent an ongoing digital conversation for a group referred to as “Cloud Media Arch . . . ” per digital conversation label 110). It will be appreciated that due to display constraints, digital conversation label 110 may represent a truncated version of the name of the group participating in the ongoing digital conversation. A user, i.e., one of the participants in the digital conversation, may select annotation button 120 to enter an annotation mode for the underlying application of display 100. As depicted in FIG. 1, this selection may be performed by tapping on annotation button 120.

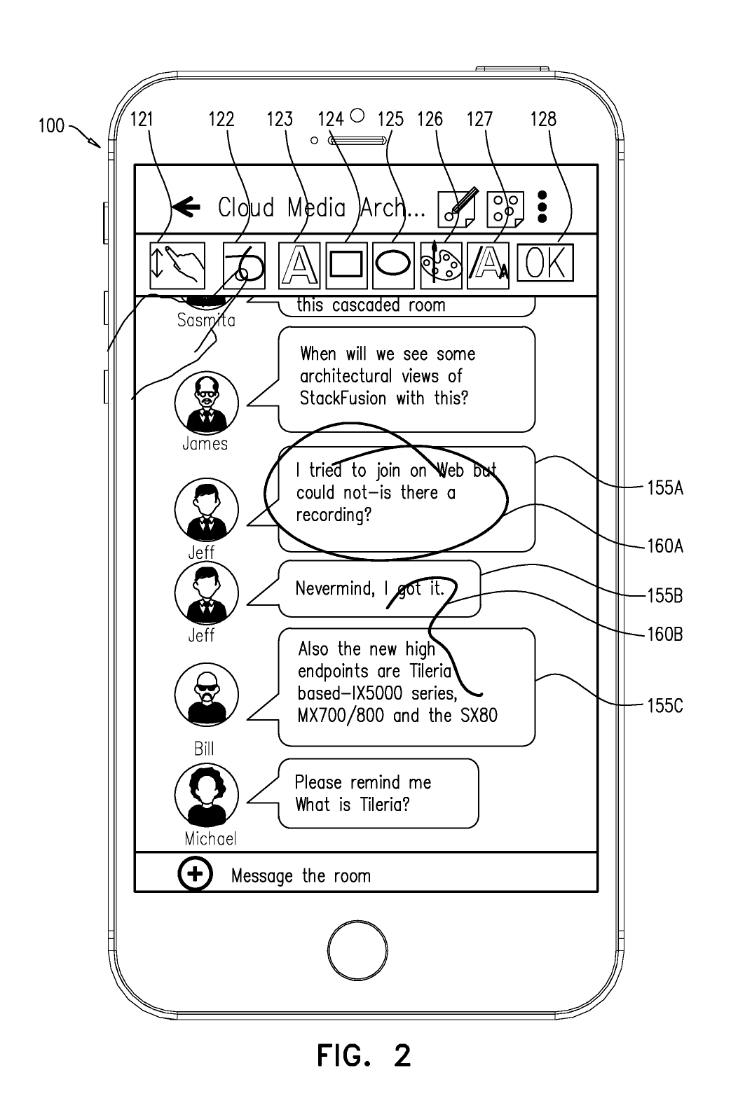

Reference is now made to FIG. 2 which is a simplified pictorial illustration of display 100, depicting another view of display 100 subsequent to the selection of annotation button 120 as described with reference to FIG. 1. Similar reference numerals refer to similar elements. Display 100 comprises scroll button 121, free form drawing button 122, text input button 123, rectangle insertion button 124, ellipse insertion button 125, color palette button 126, Font button 127, confirmation button 128. As will be described hereinbelow, buttons 121-128 may be used singly or in combination to annotate participant posts 155.

For example, as depicted in FIG. 2, the user may select free style drawing button 122 to enter a free form drawing annotation sub-mode. Once in free form drawing annotation sub-mode, the user may use any suitable method to draw annotations on display 100. For example, the user may use a finger or stylus in contact with a touchscreen to draw free form annotations 160A and 160B. Alternatively, or in addition, if a mouse is available, free form annotations 160 may be input by clicking and dragging the mouse over display 100.

It will be appreciated that a given free form annotation 160 may not necessarily be associated with only one corresponding participant post 155. For example, while free form annotation 160A may be depicted as a circle drawn around the text of participant post 155A, free form annotation 160B may be drawn as a question mark over parts of both participant posts 155B and 155C.

It will be appreciated that display 100 may support the use of different colors for the input annotations. Color palette button 126 may be selected by the user to select and/or change an annotation's color from among available colors.

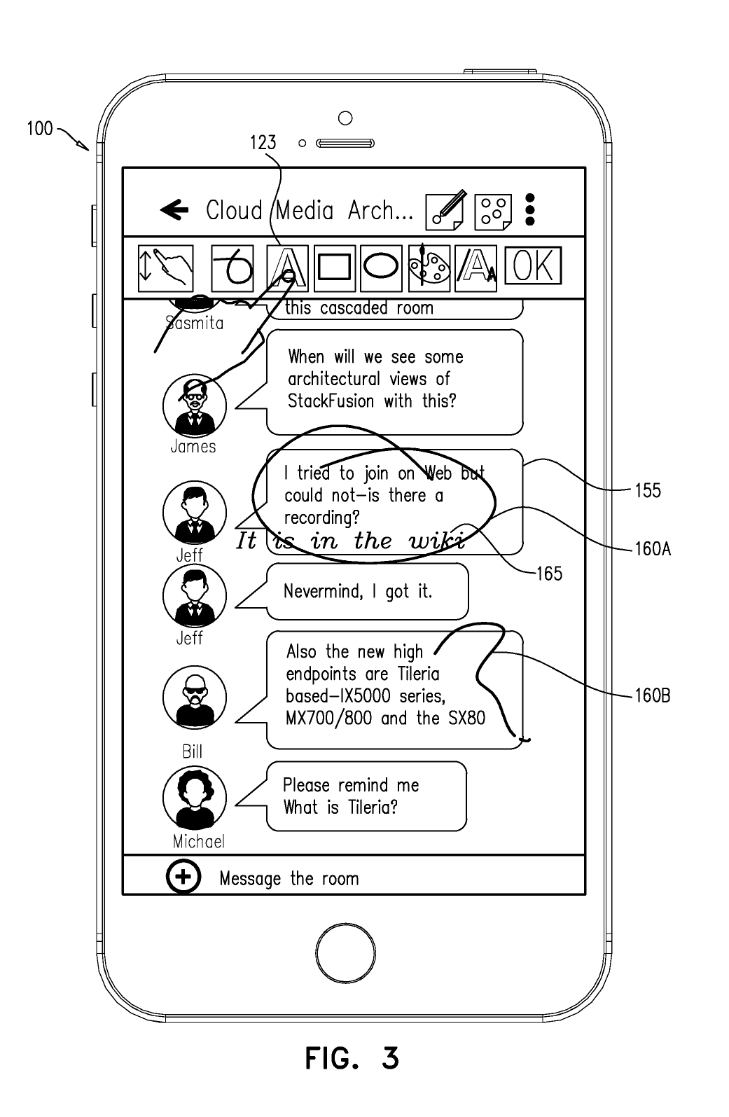

Reference is now made to FIG. 3 which is a simplified pictorial illustration of display 100, depicting a view of display 100 as the user selects text input button 123, subsequent to the selection of annotation button 120 as described with reference to FIG. 1. Similar reference numerals refer to similar elements.

Selection of text input button 123 may result in display 100 entering a text input annotation sub-mode for the input of a textual annotation. For example, once in text input annotation sub-mode, the user may select participant post 155, e.g., by tap, mouse click, or menu selection, to input a text annotation. Once so selected, the user may input a text annotation 165 to be associated with participant post 155. For example, as per the depiction in FIG. 1, the user may input “It is in the Wiki” using standard means and methods available to the user to input text on the device of display 100. It will be appreciated that in accordance with the embodiments described herein, the annotations entered by the user need not be inter-dependent; e.g., free form annotations 160A and 160B may not be affected by, or dependent on, the addition of text annotation 165.

It will be appreciated that display 100 may support the use of different fonts for the input annotations. Font button 127 may be selected by the user to select and/or change an annotation's font from among available fonts.

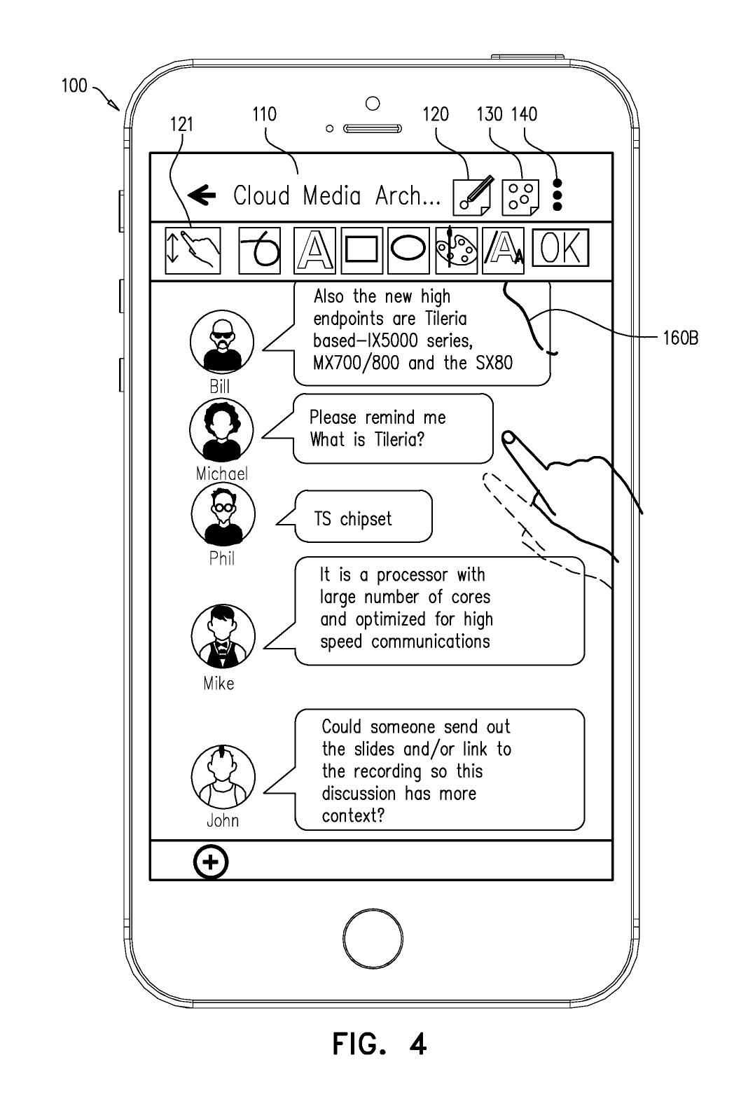

Reference is now made to FIG. 4 which is a simplified pictorial illustration of display 100, depicting a view of display 100 subsequent to a user selection of scroll button 121. It will be appreciated that it may be difficult to definitively differentiate between standard scrolling gestures and free form annotation gestures. Therefore, in accordance with some embodiments described herein, standard scrolling may be turned off for at least some of the annotation sub-modes described herein. Accordingly, in order to scroll during annotation mode, the user may first select scroll button 121 before using a scroll motion to navigate within display 100 (as depicted in FIG. 4), thereby avoiding potential conflicts between gestures used for annotation entry and scrolling.

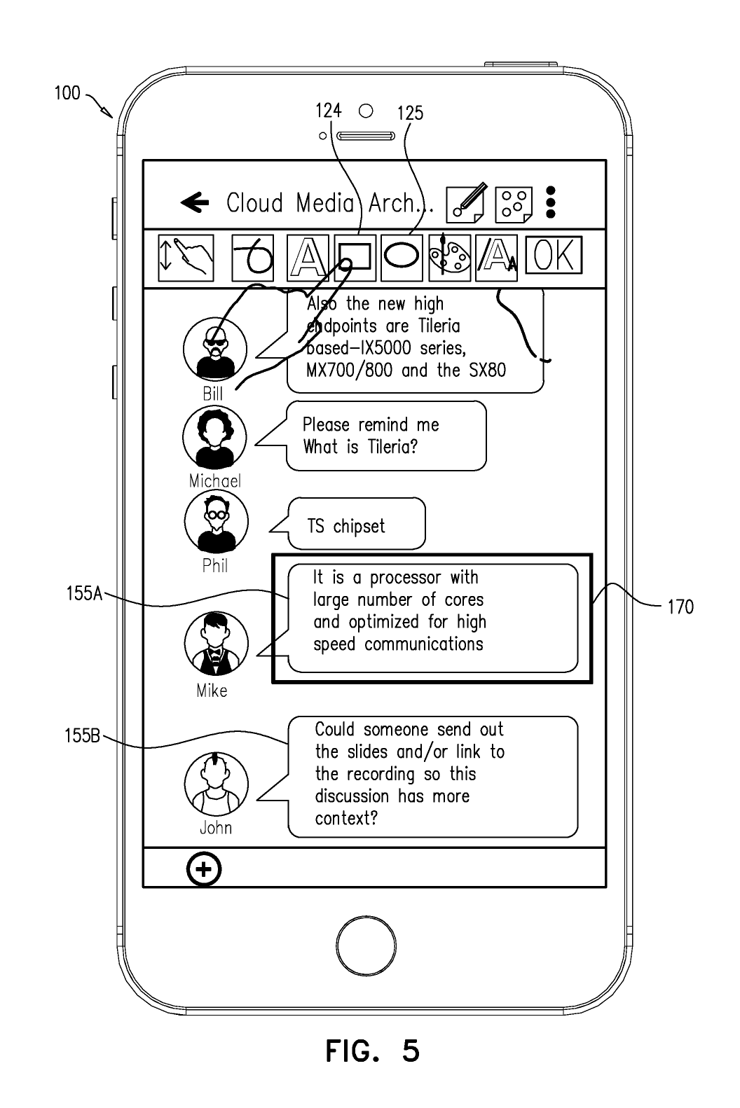

Reference is now made to FIG. 5 which is a simplified pictorial illustration of display 100, depicting a view of the user of display 100 selecting rectangle insertion button 124. Subsequent to a user selection of rectangle insertion button 124, display 100 may enter a rectangle annotation sub-mode for the input of a rectangular annotation surrounding one or more participant posts 155. For example, once in rectangle annotation sub-mode, the user may select participant post 155A, using any suitable user interface (UI) gesture, such as, for example, tapping, double tapping, tapping and holding, mouse clicking, menu selection, etc. As depicted in FIG. 5, subsequent to the user's selection of participant post 155A it is encompassed by rectangular annotation 170.

Alternatively, or in addition, a rectangular annotation may not necessarily be dependent on a specific participant post 155. Accordingly, the user may use a tap and drag UI gesture to define a rectangular annotation that, similar to the free form annotations described hereinabove, may surround or be superimposed on multiple participant posts 155, or at least parts thereof. For example, in such manner the user may define a rectangular annotation covering at least part of participant post 155B as well (not shown).

It will be appreciated that ellipse insertion button 125 may be used in a generally similar manner as rectangle insertion button 124, where ellipses may be defined instead of, or in addition to, rectangles. It will similarly be appreciated that the embodiments described herein may generally support the insertion of any geometrically shaped annotation in a generally similar manner.

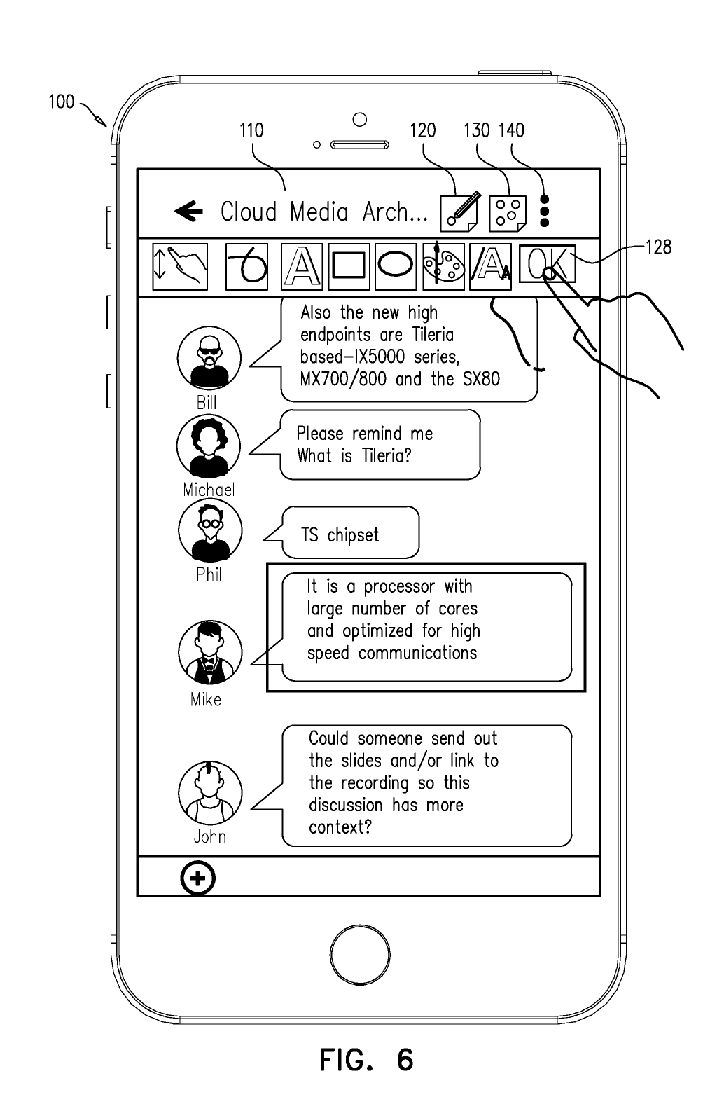

Reference is now made to FIG. 6 which is a simplified pictorial illustration of display 100, depicting a view of the user of display 100 selecting confirmation button 128. Selection of confirmation button 128 may indicate that the annotations entered in the current annotation session (i.e., subsequent to the selection of annotation button 120 as described with respect to FIG. 1) are to be saved and forwarded to relevant co-participants of the digital conversation. It will be appreciated that the specific types and combinations of annotations described with respect to FIGS. 1-5 are exemplary; in accordance with embodiments described herein, in a given annotation session display 100 may support the entry of a single or multiple annotations of one or more annotation types, e.g., free form, text, rectangular, elliptical, etc.

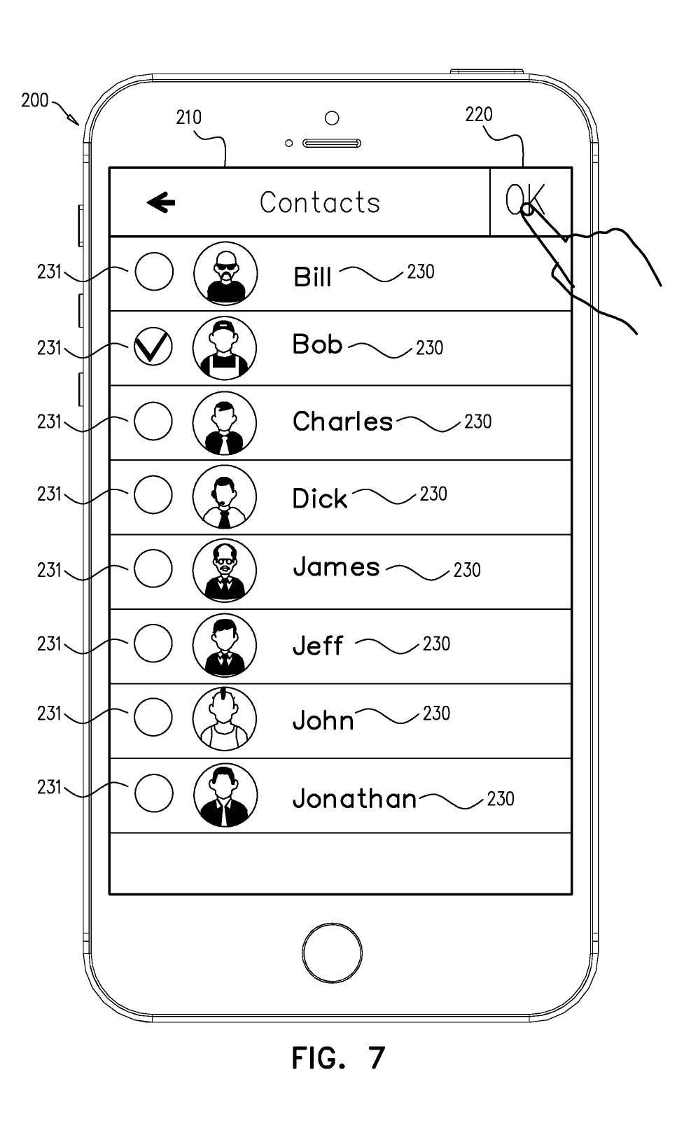

Reference is now made to FIG. 7 which is a simplified pictorial illustration of an exemplary contact display 200, constructed and operative in accordance with embodiments described herein. Contact display 200 comprises display label 210, confirmation button 220, contacts 230, and contact checkboxes 231. Contact display 200 may be displayed in response to the selection of confirmation button 128 as described with respect to FIG. 6.

It will be appreciated that each contact checkbox is associated with a contact 230, and contacts 230 may be associated with participants of the digital conversation for which the annotations described hereinabove were entered. The user may select one or more checkboxes to indicate which participants should receive the annotations entered in the current annotation session. For example, as depicted in FIG. 7, in accordance with an exemplary embodiment the user may select to send the annotations to a contact named “Bob”. Once the user has selected the contact(s) to receive the annotations, the user may select confirmation button 220 (as depicted in FIG. 7) to send the annotations, thereby sharing the annotations with the selected contacts 230. It will be appreciated that the annotations may be sent to other participants of the digital conversation using the same functionality by which the collaboration application shares participant posts between participants.

Alternatively, or in addition, the conversation participant(s) that posted the participant post(s) (e.g., participant post 155 from FIG. 1) associated with the annotation(s) may be selected for receipt by default, i.e., an annotation may be shared by default with the original poster of an associated participant post 155.

In accordance with embodiments described herein, additional contacts 230 may also be selected at a later time. For example, after sending an annotation to be shared with “Bob” as per the exemplary embodiment of FIG. 7, the user may access contact display 200 a second time (i.e., in a second processing session associated with an already saved and sent annotation) to add an additional contact 230 to receive the annotation. For example, the user may later send the annotation to “James”.

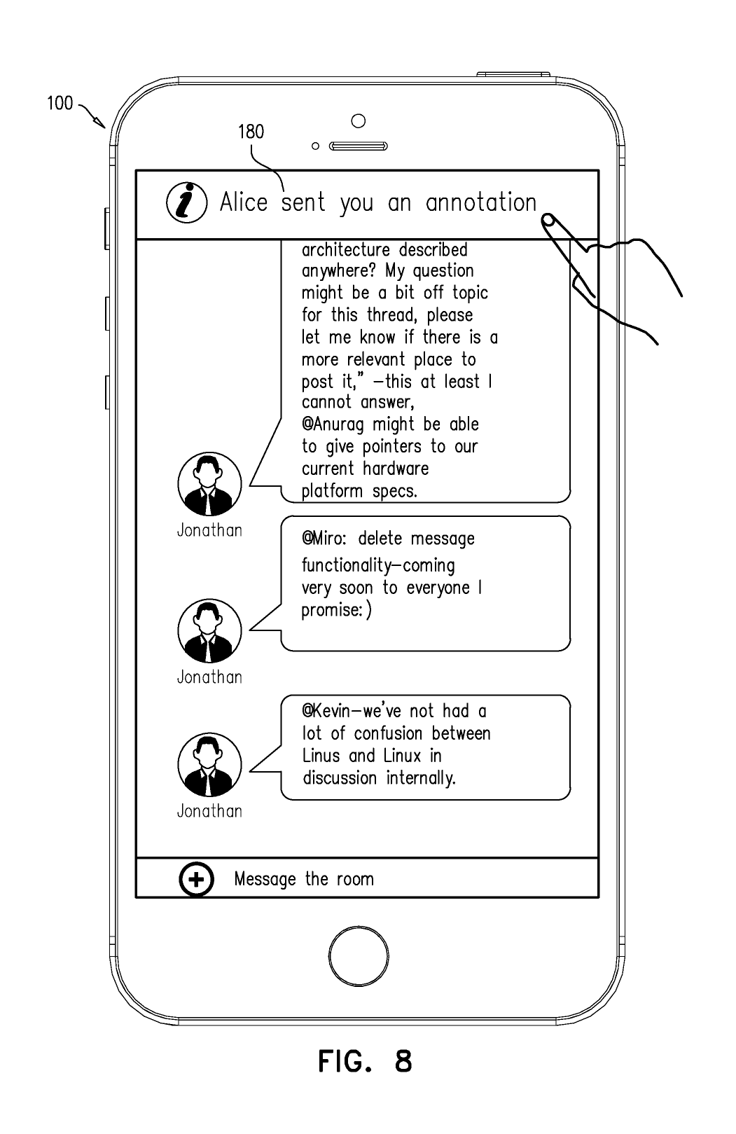

Reference is now made to FIG. 8 which is a simplified pictorial illustration of an exemplary view of display 100 as presented to another participant of the same digital conversation. For example, FIG. 8 may depict display 100 as presented on a device associated with digital conversation participant “Bob”, i.e., the contact to whom the annotations were sent as per the exemplary embodiment of FIG. 7.

In accordance with the exemplary embodiment of FIG. 8, the user of display 100 in the exemplary embodiments of FIGS. 1-6 may be named “Alice”. Accordingly, when the annotations are received on Bob's device, display 100 may notify Bob. For example, as depicted in FIG. 8, display 100 may comprise annotation notice 180 with the exemplary notification: “Alice sent you an annotation”. Bob, i.e., the user of display 100, may then select annotation notice 180 to access the annotation(s) that Alice sent. It will be appreciated that any suitable UI gesture may be used to select annotation notice 180, such as, for example, tapping, double tapping, tapping and holding, mouse clicking, mouse selection, etc.

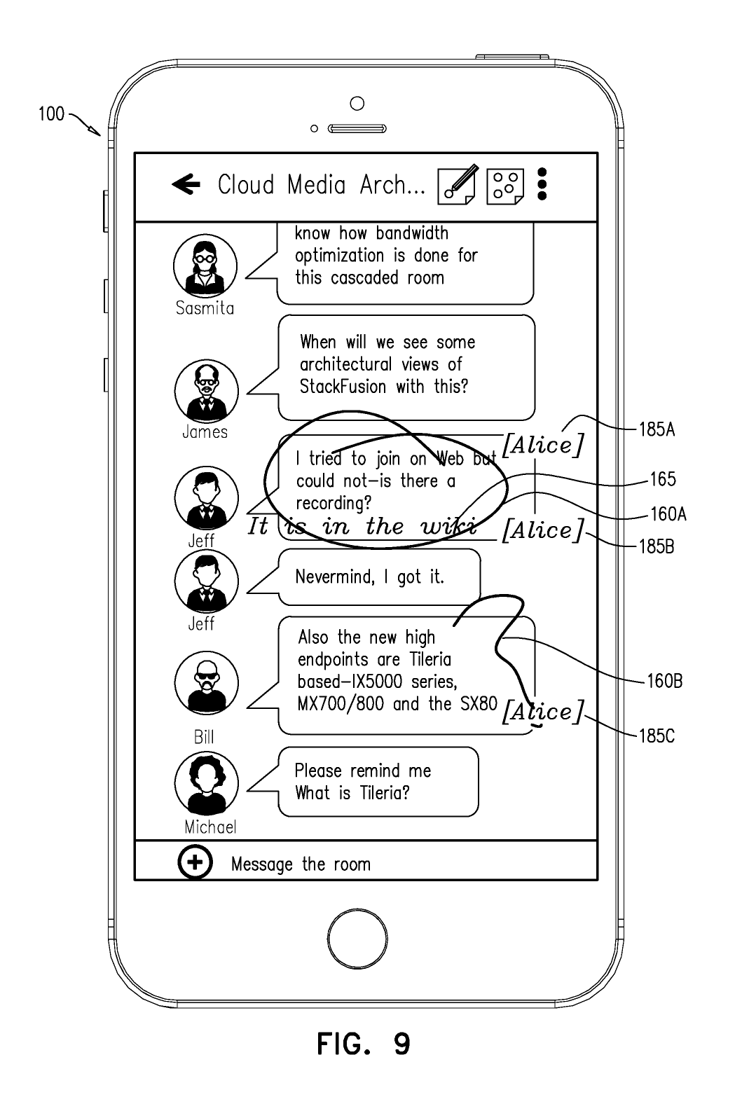

Reference is now made to FIG. 9 which is a simplified pictorial illustration of display 100 as presented after the user selection of annotation notice 180 as depicted in FIG. 8. In accordance with embodiments described herein, in response to user selection of annotation notice 180, display 100 may present at least the first of the associated annotations from the sending participant, i.e., Alice, as per the exemplary embodiment of FIG. 8. Accordingly, for example, display 100 may comprise free form annotations 160A and 160B, as well as text annotation 165 as entered in the exemplary embodiments of FIGS. 2 and 3. Display 100 may also comprise author names 185 to indicate the author of the annotations (i.e., Alice, per the exemplary embodiment) to the user of display 100 (i.e., Bob). For example, author name 185A may indicate that Alice provided free form annotation 160A; author name 185B may indicate that Alice provided text annotation 165 and author name 185C may indicate that Alice provided free form annotation 160B.

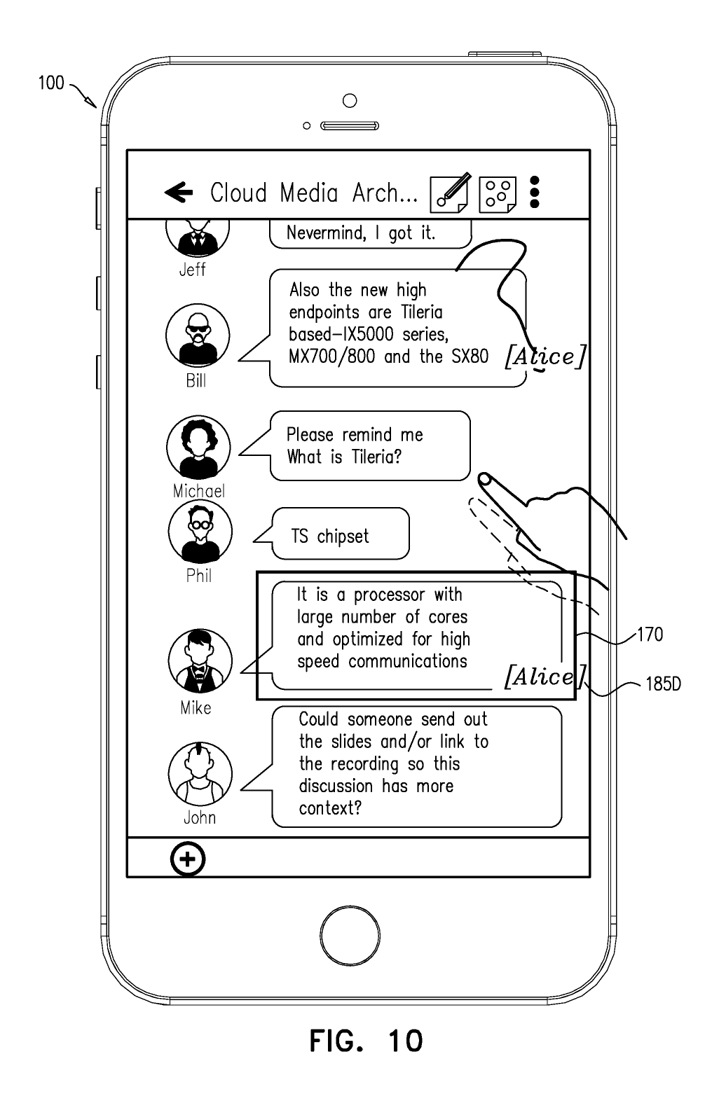

In accordance with embodiments described herein, the user may navigate within display 100 to bring other annotations into view. |For example, as depicted in FIG. 10, to which reference is now briefly made, the user may use standard scrolling (or any other suitable means, such as, but not limited to, mouse clicks, arrow buttons, and menu selections) to present other annotations such as rectangular annotation 170 along with associated author name 185D.

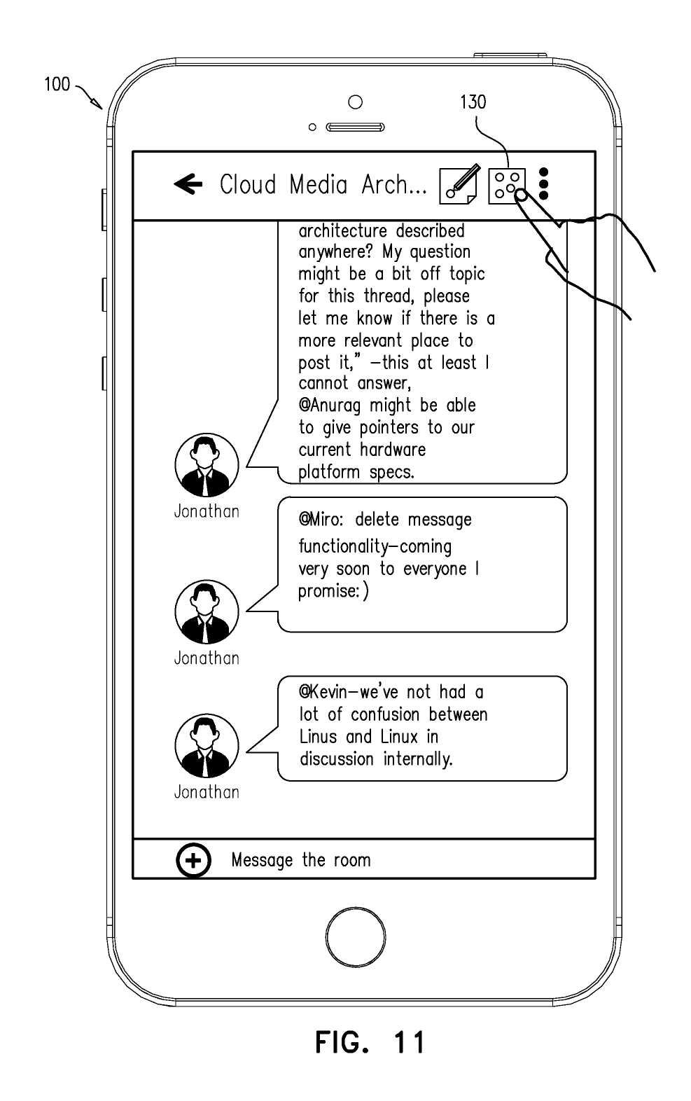

Reference is now made to FIG. 11 which is a simplified pictorial illustration of display 100, depicting a view of the user of display 100 selecting annotation view button 130. It will be appreciated that a view of the annotations in a digital conversation may be useful for the purposes of access and/or review. Display 100 may be configured to provide such a view in response to the user selecting annotation view button 130 as depicted in FIG. 11.

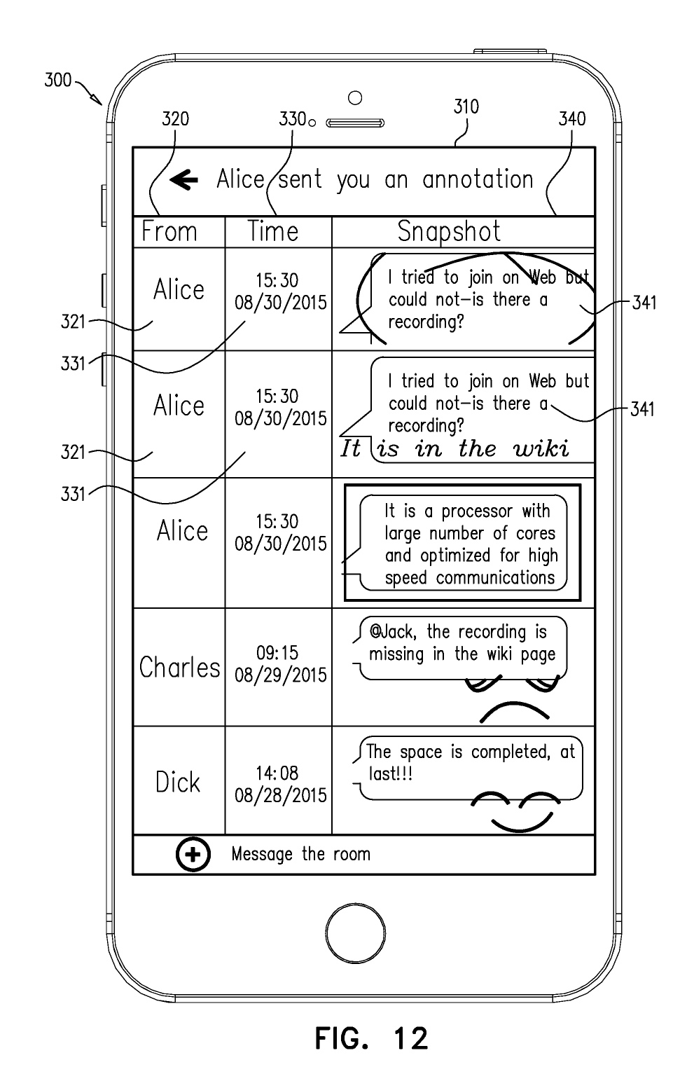

Reference is now made to FIG. 12 which is a simplified pictorial illustration of annotation view 300, constructed and operative in accordance with embodiments described herein. Annotation view 300 comprises annotation notification 310, from column 320, time column 330, and snapshot column 340. It will be appreciated that annotation view 300 may be accessed and presented in response to the user selection of annotation view button 130 as described with respect to FIG. 11.

In accordance with embodiments described herein, a user may navigate to a given annotation display 100 (as per FIGS. 1-6) by selecting an annotation from annotation view 300. For example, each annotation in annotation view 300 may be represented by associated entries for annotation author 321, annotation time 331, and annotation snapshot 341, where annotation snapshot depicts an image of the annotation as it may appear in display 100. It will be appreciated that any suitable UI gesture may be employed to select an annotation, such as, for example, tapping, double tapping, mouse clicking, menu selection, etc. In accordance with embodiments described herein, a suitable UI gesture may also be employed to delete a selected annotation. Similarly, a selected annotation may be modified, or partially erased using functionality similar to that described hereinabove for the initial entry and saving annotations.

In accordance with embodiments described herein, the order of presentation of the annotations may be in reverse chronological order as per the entries for annotation time 331. However, it will be appreciated that the order may be sortable in accordance with user preference, either by configurable default or proactive sorting. For example, the user may double tap (or double click, select via menu, etc.) on from column 320 or time column 330 to sort the annotations according to annotation authors 321 or annotation times 331.

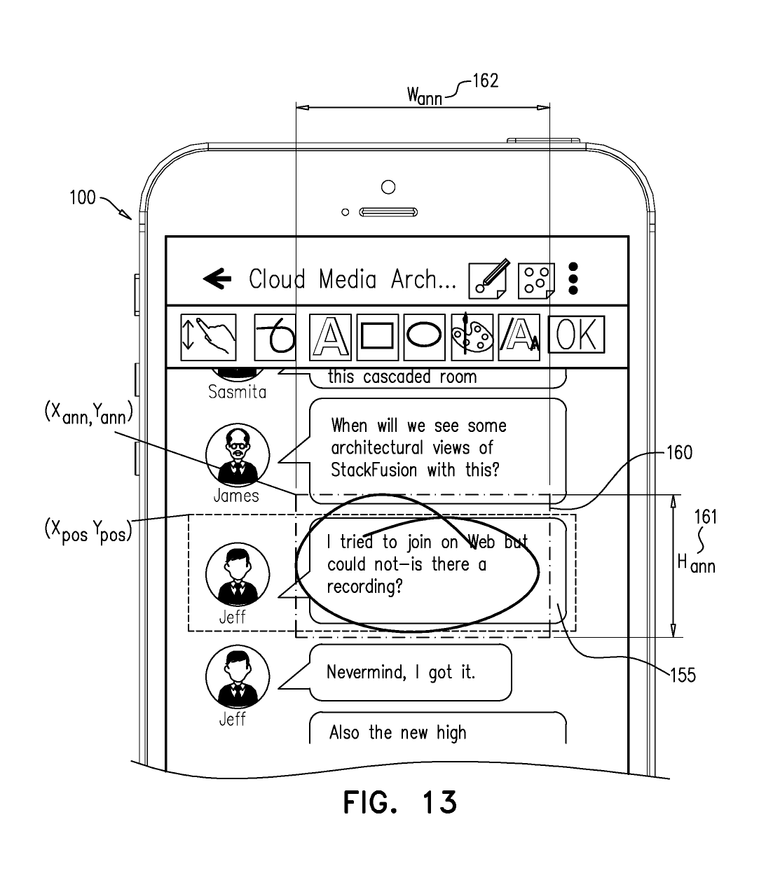

Reference is now made to FIG. 13 which is a simplified pictorial illustration of display 100, depicting the use of vectors to save the relative position and save of an annotation. In accordance with embodiments described herein, an annotation mark may be saved as vector drawing. The relative position and size vis-à-vis corresponding participant posts may be saved together to facilitate representation in both display 100 and view 300. The author, time, and share permissions (i.e., to whom the annotation is sent for viewing) may also be saved.

For example, as depicted in FIG. 13, participant post 155 may be expressed as a vector drawing with coordinates (Xₚₒₛ, Yₚₒₛ), and free form annotation 160 may expressed as a vector drawing with coordinates (Xₚₒₛ, Yₚₒₛ), where coordinates (Xₐₙₙ, Yₐₙₙ) indicate a start position of free form annotation 160, and (Wₐₙₙ, Hₐₙₙ) indicate its (i.e., free form annotation 160) width and height, thereby serving to provide positioning of free form annotation 160 relative to participant post 155. The annotations (e.g., free form annotation 160) may then be drawn in a presentation upper layer, i.e., superimposed on participant post 155, for viewing by a user with the appropriate share permissions.

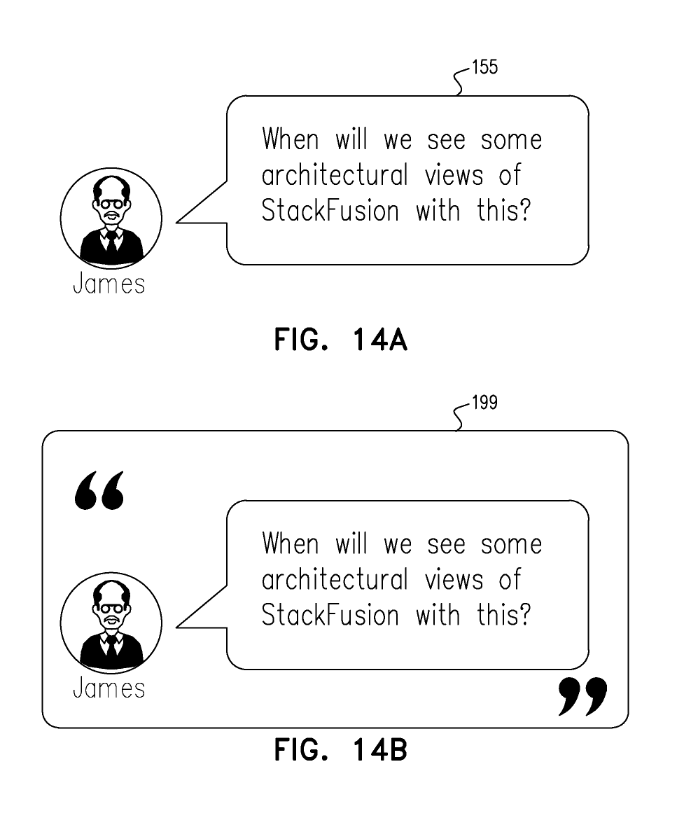

Reference is now made to FIGS. 14A and 14B. FIG. 14A depicts an exemplary participant post 155. The embodiments described herein may also support a quotation annotation mode. For example, the user may switch to a quotation mode and select participant post 155. As depicted in FIG. 14B, the contents of participant post 155 may then be included for display in quotation annotation 199. Quotation annotation 199 may then be sent to one or more of the other participants in generally the same manner as described hereinabove. The embodiments described herein may also provide similar support for marking or highlighting some of the words in a given participant post 155. Similarly, the embodiments described herein may provide support for selecting annotations to be modified and/or deleted.

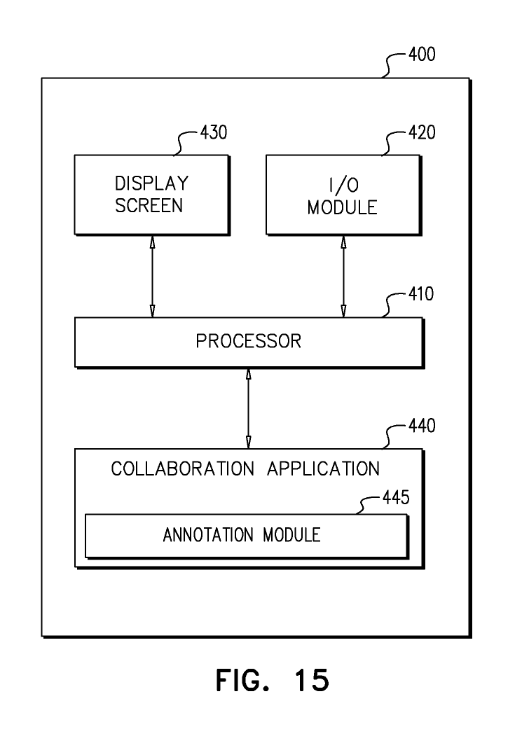

Reference is now also made to FIG. 15 which is a block diagram of a computing device 400 constructed and operative in accordance with embodiments described herein to provide an exemplary collaboration application 440 configured to present displays 100/200 and view 300 as described with respect to FIGS. 1-14B. Computing device 300 may be implemented as any suitable computing device such as, but not limited to, a personal computer, laptop computer, computer tablet, or smartphone that may be operative to provide the functionality described hereinabove with reference to FIGS. 1-14B.

It will be appreciated by one of skill in the art that computing device 400 comprises hardware and software components that may provide at least the functionality of the embodiments described herein. For example, computing device 400 may comprise at least processor 410, I/O module 420, display screen 430, and collaboration application 440. I/O module 420 may be implemented as a transceiver or similar means suitable for transmitting and receiving data between computing device 400 and another device. Such data may be, for example, participant posts 155 (FIG. 1) and annotations as described hereinabove. In accordance with some embodiments described herein, display screen 430 may be implemented as a touchscreen to detect the direct input of UI gestures, however, as noted hereinabove, menu selections and/or mouse clicks may be used to compensate for a lack of touchscreen functionality. It will be appreciated that display screen 430 may be implemented as a built-in integrated component of computing device 400, or alternatively as an attached peripheral device.

Collaboration application 440 may be any suitable application implemented in software and/or hardware that may be operative to facilitate a user's ongoing participation in a digital conversation as described hereinabove. For example, collaboration application 440 may be implemented as Cisco Spark®. It will, however, be appreciated that collaboration 440 may be implemented as any suitable IM, collaboration, and/or social network application that supports ongoing digital conversations between multiple participants, such as, for example, Jabber®, WhatsApp®, or Facebook®.

It will be appreciated that computing device 400 may comprise more than one processor 410. For example, one such processor 410 may be a special purpose processor operative to execute collaboration application 440. Client application 440 comprises annotation module 445. Annotation module 445 may be implemented in software and/or hardware and may be employed as necessary by collaboration application 440 to input, modify, delete and/or present annotations for digital conversation communications transmitted/received by collaboration application 440, typically via I/O module 420. It will be appreciated by one of ordinary skill in the art that some or all of the functionality of annotation module 445 may be implemented on a collaboration server (not shown) that may be configured to facilitate collaborative communications between collaboration applications 440 on different computing devices 400. For example, the collaboration server may store some or all of the digital conversation history displayed in display 100 or view 300 as described hereinabove. The collaboration server may also perform indexing of the digital conversation and associated annotations in order to provide annotations and/or associated participation posts for display by collaboration application 440 and/or annotation module 445.

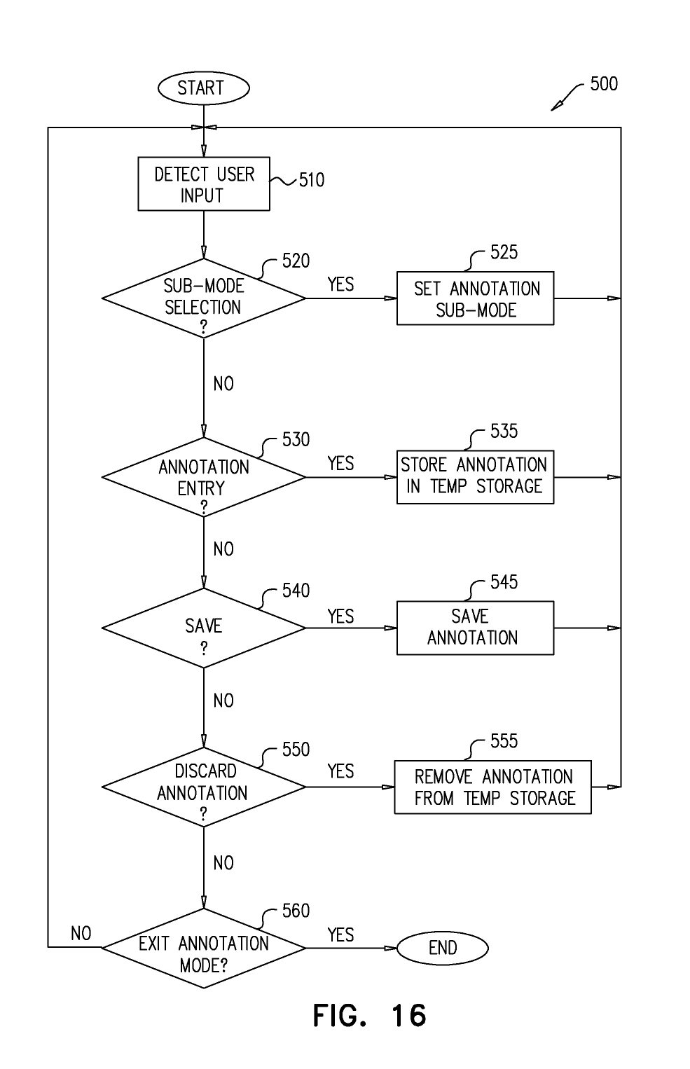

Reference is now also made to FIG. 16 which illustrates an annotation process 500, constructed and operative in accordance with embodiments described herein. It will be appreciated by a person of ordinary skill in the art that collaboration application 440 may comprise functionality as known in the art for the support of a user's ongoing participation in a digital conversation. Process 500 may be used by collaboration application 440 and/or annotation module 445 to generate and/or manage annotations for an ongoing digital conversation. Collaboration application 440 may therefore employ annotation module 445 to execute process 500 in response to a user selection of annotation button 120 as described with respect to FIG. 1.

Annotation module 445 may detect (step 510) user input, e.g., a UI gesture, textual input, etc. If the user input represents selection of an annotation sub-mode (step 520), annotation module 445 may set an annotation sub-mode in accordance with the user selection (step 525). For example, as described hereinabove, the annotation sub-mode may be free form drawing, text input, rectangular annotation, elliptical annotation, quotation, etc. As described hereinabove, process 500 may be configured to interpret any suitable UI gesture for the selection of the annotation sub-mode. Once the annotation sub-mode has been set, processing control may return to step 510.

Otherwise, if the user input represents an annotation entry (step 530)—e.g., a free form drawing, textual input, a quotation, and the placement of a rectangle or ellipse—annotation module 445 may store (step 535) the input annotation in temporary storage on computing device 400, subject to confirmation by the user. Once the annotation has been stored, processing control may return to step 510.

Otherwise, if the user input represents a request by the user to save an annotation (step 540), annotation module 445 may save (step 545) the annotation, for example, as a drawing vector as described hereinabove. It will be appreciated that the save operation may also include facilitating the selection of participants with which the annotation should be shared from a contact list of digital conversation participants as described hereinabove, i.e., the setting of sharing permissions. Collaboration module 440 may also send the saved annotation to other participants of the digital conversation via I/O module 420 in accordance with the sharing permissions set for the annotation.

Otherwise, if the user input represents a request by the user to discard an annotation without saving (step 550), annotation module 445 may remove (step 555) the annotation from the temporary storage. It will be appreciated that annotation module 445 may also refresh the display on display screen 430 to remove the discarded annotation from the presentation of the digital conversation.

Otherwise, if the user input represents a request by the user to exit annotation mode (step 560), process 500 may end. It will be appreciated that any suitable UI input may be configured to represent a request to end the process. For example, depending on the operating system and/or the presence of a touchscreen, mouse and/or keyboard, a request to end may be input via tapping an “end” button, a mouse click on a window close symbol (typically, although not necessarily an “X”), an ALT-F4 keystroke combination, selecting an application exit menu option, etc.

Otherwise, if the user input cannot be parsed, control may return to step 510. It will be appreciated that process 500 may also support other functionality that in the interests of clarity has not been specifically detailed herein. For example, the user input detected in step 510 may represent known functionality for scrolling as discussed hereinabove. It will therefore be appreciated that process 500 may also support receiving a scrolling request and adjusting/redisplaying the affected elements as necessary.

It will be appreciated by a person of ordinary skill in the art that annotation module 445 may also be configured with additional functionality to support the changing of fonts and colors as described hereinabove. Annotation module 445 may also be configured with functionality for the modification and/or deletion of previously saved annotations.

It is appreciated that software components of the present invention may, if desired, be implemented in ROM (read only memory) form. The software components may, generally, be implemented in hardware, if desired, using conventional techniques. It is further appreciated that the software components may be instantiated, for example: as a computer program product or on a tangible medium. In some cases, it may be possible to instantiate the software components as a signal interpretable by an appropriate computer, although such an instantiation may be excluded in certain embodiments of the present invention.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

It will be appreciated by persons skilled in the art that the present invention is not limited by what has been particularly shown and described hereinabove. Rather the scope of the invention is defined by the appended claims and equivalents thereof:

What is claimed is:

1. A method for annotating digital conversations, the method implemented on a first computing device and comprising:
presenting participant posts from said digital conversation on a display screen of said first computing device;
detecting input of at least an indication of an annotation associated with at least one of said participant posts; and
presenting said annotation as superimposed on said at least one of said associated participant posts.

2. The method according to claim 1 and further comprising:
detecting input of at least an indication of at least one participant of said digital conversation;
assigning permission to said at least one participant to view said annotation; and
sending said annotation to said at least one participant.

3. The method according to claim 1 and further comprising:
assigning permission to at least one participant of said digital conversation to view said annotation, wherein said at least one participant posted said at least one of said participant posts;
sending said annotation to said at least one participant.

4. The method according to claim 1 wherein said detecting input of at least an indication comprises:
detecting free form drawing of said annotation.

5. The method according to claim 1 wherein said detecting input of at least an indication comprises:
detecting text input.

6. The method according to claim 1 wherein said detecting input of at least an indication comprises:
receiving a request to associate a geometric shape with said at least one participant post.

7. The method according to claim 1 wherein said detecting input of at least an indication comprises:
receiving a request to include a quote of said at least one participant post in a new participant post.

8. The method according to claim 1 and further comprising:
saving said annotation as a vector drawing.

9. The method according to claim 1 and further comprising:
receiving said at least an indication of an annotation from a second computing device associated with a participant of said digital conversation.

10. The method according to claim 9 wherein said presenting said annotation comprises:
presenting an indication of said participant as part of said annotation.

11. The method according to claim 1 and further comprising:
presenting a sortable list of previously entered said annotations in said digital conversation.

12. The method according to claim 11 and further comprising:
detecting a selection of one of said previously entered annotations; and
enabling modification or deletion of said one of said previously entered annotations.

13. The method according to claim 12 wherein said enabling modification or deletion comprises:
detecting input of at least an indication of at least one participant of said digital conversation;
assigning permission to said at least one participant to view said annotation;
sending said annotation to said at least one participant.

14. The method according to claim 1 wherein said annotation is associated with at least two of said participant posts.

15. A method for presenting annotations in a digital conversation, the method implemented on a first computing device and comprising:
presenting participant posts from said digital conversation on a display screen of said first computing device;
receiving from a second computing device at least an indication of an annotation associated with at least one of said participant posts; and
presenting said annotation as superimposed on said at least one of said associated participant posts.

16. The method according to claim 15 wherein said at least an indication is a vector drawing associated with at least one said participant posts.

17. The method according to claim 15 wherein said at least an indication represents one of a free form drawing, text, geometric shape, or quotation.

18. The method according to claim 15 wherein said presenting comprises presenting at least an indication of a user associated with said second computing device.

19. A digital conversation device comprising:
means for displaying participant posts from a digital conversation;
means for detecting input of at least an indication of an annotation associated with at least one of said participant posts; and
means for presenting said annotation as superimposed on said at least one of said associated participant posts.

20. The method according to claim 19 and further comprising:
means for detecting input of at least an indication of at least one participant of said digital conversation;
means for assigning permission to said at least one participant to view said annotation; and
means for sending said annotation to said at least one participant.
